(19) United States
(12) Patent Application Publication
(10) Pub. No.: US 2025/0259780 A1
(43) Pub. Date: Aug. 14, 2025

(54) MULTILAYER INDUCTOR

(71) Applicant: Murata Manufacturing Co., Ltd., Kyoto-fu (JP)

(72) Inventor: Kaito SUZUKI, Nagaokakyo-shi (JP)

(73) Assignee: Murata Manufacturing Co., Ltd., Kyoto-fu (JP)

(21) Appl. No.: 19/047,344

(22) Filed: Feb. 6, 2025

(30) Foreign Application Priority Data
Feb. 9, 2024 (JP) 2024-018496

(51) Int. Cl. H01F 27/28; H01F 27/29

(52) U.S. Cl. CPC H01F 27/2852; H01F 27/292

(57) ABSTRACT

A multilayer inductor includes a main body having first and second end surfaces opposite to each other in a first direction; first and second outer electrodes on the first and second end surfaces, respectively; an inner conductor inside the main body and wound around a coil axis extending in a coil-axis direction that is orthogonal to the first direction; first and second extended conductors inside the main body to connect the inner conductor to the first and second outer electrodes, respectively. As viewed through in the coil-axis direction, a straight line drawn in the first direction from a first boundary between the first extended and inner conductors does not superpose a second boundary between the second extended and inner conductors. As viewed through in the coil-axis direction, the second extended conductor is curved such that the curved portion projects in a direction extending away from the straight line.

### CROSS-REFERENCE TO RELATED APPLICATION

This application claims benefit of priority to Japanese Patent Application No. 2024-018496, filed Feb. 9, 2024, the entire content of which is incorporated herein by reference.

### BACKGROUND

### Technical Field

The present disclosure relates to a multilayer inductor.

### Background Art

Japanese Unexamined Patent Application Publication No. 5-190364 discloses a multilayer chip common-mode choke coil. The multilayer chip common-mode choke coil is formed by laminating multiple magnetic sheets having respective conductor traces formed thereon. The conductor traces are connected by through-holes to form a pair of coils, and extended electrodes are extended from both ends of each coil to different positions at edges of the laminated magnetic sheets, and each extended electrode of the coil has a wide portion near the edge of the laminated magnetic sheets.

Japanese Unexamined Patent Application Publication No. 2001-126923 discloses a multilayer inductor. The multilayer inductor is formed by alternately laminating insulating layers and conductor traces, and the conductor traces are connected in series to form a coil in an insulating body in such a manner that turns of the coil superpose each other in the lamination direction. Both ends of the coil are connected to outer electrodes using respective extended conductors. The multilayer inductor is mounted on a circuit board. In the multilayer inductor, the inductance generated between one of the extended conductors and the circuit board is matched to the inductance generated between the other extended conductor and the circuit board by adjusting the length of each extended conductor in accordance with the distance between the extended conductor and the circuit board.

Japanese Unexamined Utility Model Registration Application Publication No. 5-69915 discloses a multilayer chip inductor. The multilayer chip inductor includes a magnetic body and a helically wound coil formed inside the magnetic body. The multilayer chip inductor also includes outer terminal electrodes and extension conductors. The extension conductors connect both ends of the coil conductor to respective outer terminal electrodes formed on the end surfaces of the chip. Each extension conductor is disposed at a position away from the helical portion of the coil and near a surface of the chip, and a columnar thin electrode is provided to connect the extension conductor to the end of the coil conductor.

### SUMMARY

In the common-mode choke coil illustrated in FIG. 7 of Japanese Unexamined Patent Application Publication No. 5-190364 and also in the multilayer inductor illustrated in FIG. 1(b) of Japanese Unexamined Patent Application Publication No. 2001-126923, the extended conductors are extended linearly from a straight portion of the coil to respective sides as viewed through in the coil-axis direction. Disposing the extended conductors so as to extend linearly from the straight portion of the coil to respective sides reduces the degree of freedom of positioning the connection portion between each extended conductor and the inner conductor (i.e., the conductor of the coil). This increases the difficulty of adjusting the electrical characteristics such as inductance by changing the position of the connection portion between each extended conductor and the inner conductor.

In the multilayer chip inductor illustrated in FIG. 5 of Japanese Unexamined Utility Model Registration Application Publication No. 5-69915, as viewed through in the coil-axis direction, one of the extended conductors extends in the same direction of the inner conductor turning around the coil axis (direction of circling path of the coil), whereas the other extended conductor extends in the direction opposite to the direction of the inner conductor turning around the coil axis. When the extended conductor extends in the direction opposite to the direction of the inner conductor turning around the coil axis, the direction of electric current changes abruptly at the connection portion between the extended conductor and the inner conductor. This may deteriorate the electrical characteristics, such as the Q-value expressed in the following equation: Q=2π×f×L/R (where L: inductance, R: resistance, f: frequency).

Accordingly, an object of the present disclosure is to provide a multilayer inductor that can improve the inductance and the Q-value.

According to an aspect of the present disclosure, a multilayer inductor includes a main body having a first end surface and a second end surface that are opposite to each other in a first direction; a first outer electrode formed on the first end surface; a second outer electrode formed on the second end surface; an inner conductor formed inside the main body and wound around a coil axis extending in a coil-axis direction that is orthogonal to the first direction; a first extended conductor formed inside the main body so as to connect the inner conductor to the first outer electrode; and a second extended conductor formed inside the main body so as to connect the inner conductor to the second outer electrode. As viewed through in the coil-axis direction, when a straight line is drawn in the first direction from a first boundary between the first extended conductor and the inner conductor, the straight line does not superpose a second boundary between the second extended conductor and the inner conductor. In addition, as viewed through in the coil-axis direction, the second extended conductor is curved such that the curved portion projects in a direction extending away from the straight line.

According to the present disclosure, a multilayer inductor that can improve the inductance and the Q-value can be provided.

### BRIEF DESCRIPTION OF THE DRAWINGS

FIG. 1 is a schematic perspective view illustrating an example of a multilayer inductor according to a first embodiment of the present disclosure;

FIG. 2 is an example of an exploded perspective view illustrating the multilayer inductor of FIG. 1;

FIG. 3 is a view illustrating the multilayer inductor of FIG. 1 as viewed through in a coil-axis direction;

FIG. 4 is a schematic view illustrating an example of a first boundary;

FIG. 5 is a schematic view illustrating another example of the first boundary;

FIG. 6 is a view illustrating a multilayer inductor according to a second embodiment of the present disclosure as viewed through in the coil-axis direction;

FIG. 7 is a view illustrating a multilayer inductor according to a third embodiment of the present disclosure as viewed through in the coil-axis direction;

FIG. 8 is a view illustrating a multilayer inductor according to a fourth embodiment of the present disclosure as viewed through in the coil-axis direction;

FIG. 9 is a schematic perspective view illustrating an example of a multilayer inductor according to a fifth embodiment of the present disclosure;

FIG. 10 is an example of an exploded perspective view illustrating the multilayer inductor of FIG. 9; and

FIG. 11 is another example of the exploded perspective view illustrating the multilayer inductor of FIG. 1.

### DETAILED DESCRIPTION

A multilayer inductor of the present disclosure will be described. Note that the configurations described herein are not intended to limit the present disclosure and can be modified appropriately within the scope of the present disclosure. In addition, a combination of individual preferred configurations described herein is deemed to fall within the scope of the present disclosure.

Note that the embodiments described herein are examples and configurations described in different embodiments can be partially replaced or combined with one another. In embodiments to be described after the first embodiment, the description will focus on differences, and the description of the same elements as those of the first embodiment will be omitted. The description of the same advantageous effects obtained by the same configuration in different embodiments will not be repeated.

In the following description, multilayer inductors of various embodiments are generically referred to as the “multilayer inductor of the present disclosure”.

Drawings to be referred to below are schematic illustrations, and accordingly dimensions, aspect ratios, or the like may be different from those of an actual product.

In the present specification, terms used to describe a relationship between elements (for example, “parallel”, “perpendicular”, “orthogonal”, and so on) or to describe the shape of an element are not only used in their strict senses but also used in their substantially equivalent senses so as to allow for a certain range, for example, a several-percent difference.

### First Embodiment

A multilayer inductor according to a first embodiment will be described as an example of the multilayer inductor of the present disclosure.

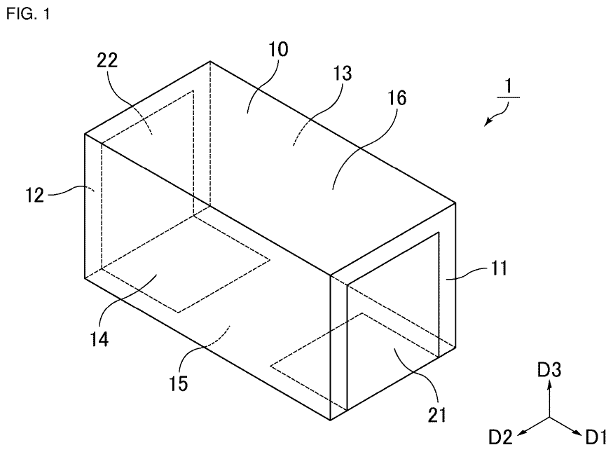

FIG. 1 is a schematic perspective view illustrating an example of the multilayer inductor according to the first embodiment of the present disclosure.

As illustrated in FIG. 1, a multilayer inductor 1 includes a main body 10, a first outer electrode 21, and a second outer electrode 22.

In the present specification, a first direction, a second direction, and a third direction are directions denoted by D1, D2, and D3, respectively, as indicated in the drawings (for example, FIG. 1). The first direction D1, the second direction D2, and the third direction D3 orthogonally intersect each other.

As illustrated in FIG. 1, the main body 10 of the multilayer inductor 1 includes a first end surface 11 and a second end surface 12 that are opposite to each other in the first direction D1, a first side surface 13 and a second side surface 14 that are opposite to each other in the second direction D2, and a first principal surface 15 and a second principal surface 16 that are opposite to each other in the third direction D3.

The first end surface 11 and the second end surface 12 of the main body 10 do not need to intersect the first direction D1 orthogonally in its strict sense. The first side surface 13 and the second side surface 14 of the main body 10 do not need to intersect the second direction D2 orthogonally in its strict sense. The first principal surface 15 and the second principal surface 16 of the main body 10 do not need to intersect the third direction D3 orthogonally in its strict sense.

For example, the main body 10 is shaped like a cuboid as illustrated in FIG. 1.

In the present specification, the term “cuboid” refers to a shape substantially like a cuboid, which encompasses a cuboid-like shape having rounded vertices and rounded edges, which will be described later.

It is preferable that the main body 10 have rounded edges and rounded vertices. The vertices of the main body 10 are portions at which three surfaces of the main body 10 intersect. The edges of the main body 10 are portions at which two surfaces of the main body 10 intersect.

The first outer electrode 21 is disposed on the first end surface 11 of the main body 10. The first outer electrode 21 is formed on part of the first end surface 11 of the main body 10 in the example illustrated in FIG. 1. The first outer electrode 21, however, may be formed entirely over the first end surface 11 of the main body 10. The first outer electrode 21 can be described as being exposed on the first end surface 11 of the main body 10.

In the example illustrated in FIG. 1, the first outer electrode 21 extends on the first end surface 11 into the first principal surface 15. In other words, the first outer electrode 21 is exposed on part of the first end surface 11 and on part of the first principal surface 15 of the main body 10. The first outer electrode 21, however, may be formed only on the first end surface 11.

The second outer electrode 22 is disposed on the second end surface 12 of the main body 10. The second outer electrode 22 is formed on part of the second end surface 12 of the main body 10 in the example illustrated in FIG. 1. The second outer electrode 22, however, may be formed entirely over the second end surface 12 of the main body 10. The second outer electrode 22 can be described as being exposed on the second end surface 12 of the main body 10.

In the example illustrated in FIG. 1, the second outer electrode 22 extends on the second end surface 12 into the first principal surface 15. In other words, the second outer electrode 22 is exposed on part of the second end surface 12 and on part of the first principal surface 15 of the main body 10. The second outer electrode 22, however, may be formed only on the second end surface 12.

The first principal surface 15 of the main body 10 serves as the mounting surface of the multilayer inductor 1. More specifically, the first principal surface 15 of the main body 10 is the mounting surface that faces an object to be mounted on (for example, a circuit board) when the multilayer inductor 1 is mounted.

The first outer electrode 21 and the second outer electrode 22 are both exposed on the first principal surface 15 (i.e., the mounting surface) of the main body 10, which improves the mountability of the multilayer inductor 1.

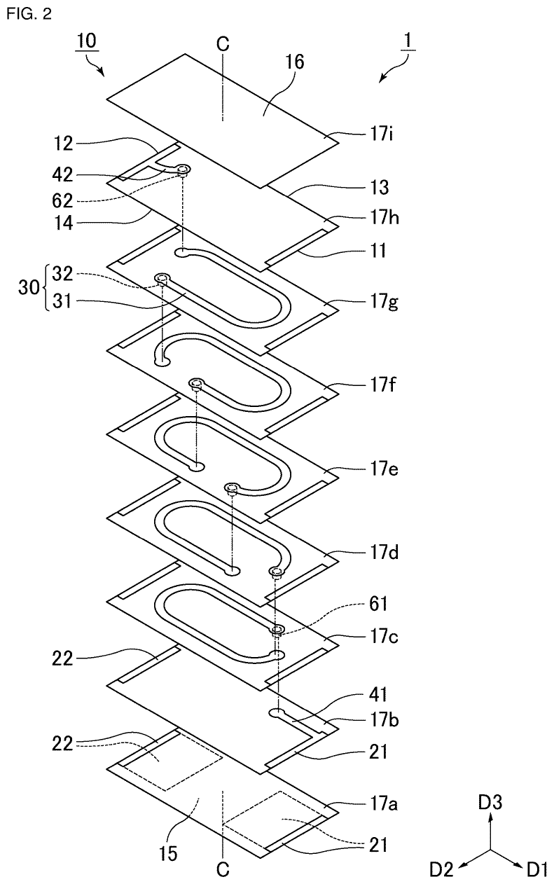

FIG. 2 is an example of an exploded perspective view illustrating the multilayer inductor of FIG. 1.

The main body 10 includes an insulator. The insulator is formed of multiple insulating layers that are laminated in a coil-axis direction C. The coil-axis direction C is the direction extending parallel to a lamination direction of the main body 10. In the example illustrated in FIG. 2, the coil-axis direction C extends parallel to the third direction D3 and orthogonal to both the first direction D1 and the second direction D2.

In the example illustrated in FIG. 2, the insulating layers include an insulating layer 17a, an insulating layer 17b, an insulating layer 17c, an insulating layer 17d, an insulating layer 17e, an insulating layer 17f, an insulating layer 17g, an insulating layer 17h, and an insulating layer 17i. The insulating layer 17a, the insulating layer 17b, the insulating layer 17c, the insulating layer 17d, the insulating layer 17e, the insulating layer 17f, the insulating layer 17g, the insulating layer 17h, and the insulating layer 17i are laminated in this order from the first principal surface 15 to the second principal surface 16 of the main body 10 in the coil-axis direction C.

Note that these insulating layers are formed integrally and boundaries between insulating layers are not likely present clearly.

For example, the insulating material of the insulator (insulating layers) is a glass material containing borosilicate glass as a main ingredient; a ceramic material; an organic material, such as epoxy resin, fluororesin, or a polymer resin; or a composite material such as glass-epoxy resin. It is preferable that the insulating material be a material of which the dielectric constant and the dielectric loss are small.

The multiple insulating layers may be made of the same insulating material or of different insulating materials, or some of the insulating layers may be made of the same insulating material.

The multiple insulating layers may have the same dimension or may have different dimensions in the coil-axis direction C, or some of the insulating layers may have the same dimension.

The multilayer inductor 1 also includes an inner conductor 30, a first extended conductor 41, and a second extended conductor 42.

The inner conductor 30 is formed inside the main body 10 and wound around the coil axis extending in the coil-axis direction C, which is orthogonal to the first direction D1.

The multilayer inductor 1 illustrated in FIG. 2 has a so-called vertical helical structure. In other words, in the multilayer inductor 1, the coil-axis direction C orthogonally intersects the first principal surface 15, or the mounting surface, of the main body 10. The first outer electrode 21 and the second outer electrode 22 are present on the first principal surface 15, which is the mounting surface of the multilayer inductor 1 that has the vertical helical structure.

In the example illustrated in FIG. 2, the inner conductor 30 includes multiple coil conductors 31 and multiple connection conductors 32.

The coil conductors 31 are electrically connected to each other via respective connection conductors 32, thereby forming a solenoid coil embedded in the main body 10.

In the example illustrated in FIG. 2, a coil conductor 31 is formed in each of the insulating layer 17c, the insulating layer 17d, the insulating layer 17e, the insulating layer 17f, and the insulating layer 17g. A connection conductor 32 is formed in each of the insulating layer 17d, the insulating layer 17e, the insulating layer 17f, and the insulating layer 17g. The connection conductor 32 is formed so as to pierce through each insulating layer.

The coil conductors 31 are made of a conductive material, such as Ag, Au, Cu, Pd, Ni, Al, or an alloy containing at least one of these.

The coil conductors 31 may be made of the same conductive material or of different conductive materials, or some of the coil conductors 31 may be made of the same conductive material.

The coil conductors 31 may have the same dimension (i.e., the same thickness) in the coil-axis direction C or may have different thicknesses, or some of the coil conductors 31 may have the same thickness.

The coil conductors 31 may have the same dimension (i.e., the same width) in the direction orthogonal to the lengthwise direction of the coil conductor 31 as viewed in the coil-axis direction C, or the coil conductors 31 may have different widths, or some of the coil conductors 31 may have the same width.

It is preferable that the coil conductors 31 overlap one another as viewed in the coil-axis direction C.

As viewed in the coil-axis direction C, the inner conductor 30 may be shaped so as to have straight portions only or curved portions only or so as to have a combination of straight portions and curved portions. For example, as viewed in the coil-axis direction C, the inner conductor 30 may be shaped like a circle, an ellipse, a stadium geometry, or a polygon. In the example illustrated in FIG. 2, the inner conductor 30 has a stadium geometry as viewed in the coil-axis direction C.

The connection conductors 32 are made of a conductive material, such as Ag, Au, Cu, Pd, Ni, Al, or an alloy containing at least one of these.

The connection conductors 32 may be made of the same conductive material or of different conductive materials, or some of the connection conductors 32 may be made of the same conductive material.

The conductive material of the connection conductors 32 may be the same as, or may be different from, the conductive material of the coil conductors 31.

The first extended conductor 41 is formed inside the main body 10 and connects the inner conductor 30 to the first outer electrode 21. In the example illustrated in FIG. 2, the first extended conductor 41 is formed in the insulating layer 17b.

The second extended conductor 42 is formed inside the main body 10 and connects the inner conductor 30 to the second outer electrode 22. In the example illustrated in FIG. 2, the second extended conductor 42 is formed in the insulating layer 17h.

The multilayer inductor 1 illustrated in FIG. 2 includes the first extended conductor 41, the inner conductor 30, and the second extended conductor 42 that are layered in this order from one side to the other in the coil-axis direction C. More specifically, the first extended conductor 41, the inner conductor 30, and the second extended conductor 42 are layered in this order from the first principal surface 15 to the second principal surface 16 of the main body 10.

The first extended conductor 41 is connected to the inner conductor 30 using a first via conductor 61, and the inner conductor 30 is connected to the second extended conductor 42 using a second via conductor 62.

The connection structure using the first via conductor 61 enables the first extended conductor 41 to be positioned away from the inner conductor 30, which can prevent short-circuiting and thereby improve reliability. In addition, this can reduce the likelihood of interference of magnetic flux, thereby improving the inductance and the Q-value of the multilayer inductor 1.

Similarly, the connection structure using the second via conductor 62 enables the second extended conductor 42 to be positioned away from the inner conductor 30, which can prevent short-circuiting and thereby improve reliability. In addition, this can reduce the likelihood of interference of magnetic flux, thereby improving the inductance and the Q-value of the multilayer inductor 1.

The first via conductor 61 may be formed so as to pierce through a single insulating layer or through multiple insulating layers. Similarly, the second via conductor 62 may be formed so as to pierce through a single insulating layer or through multiple insulating layers.

The first extended conductor 41 may be connected to the inner conductor 30 without using the via conductor (the illustration is omitted). In other words, the first extended conductor 41 and the inner conductor 30 may be present on the same insulating layer and connected to each other directly.

The second extended conductor 42 may be connected to the inner conductor 30 without using the via conductor (the illustration is omitted). In other words, the second extended conductor 42 and the inner conductor 30 may be present on the same insulating layer and connected to each other directly.

Alternatively, one of the first extended conductor 41 and the second extended conductor 42 may be connected to the inner conductor 30 using the via conductor, and the other may be connected to the inner conductor 30 without using the via conductor.

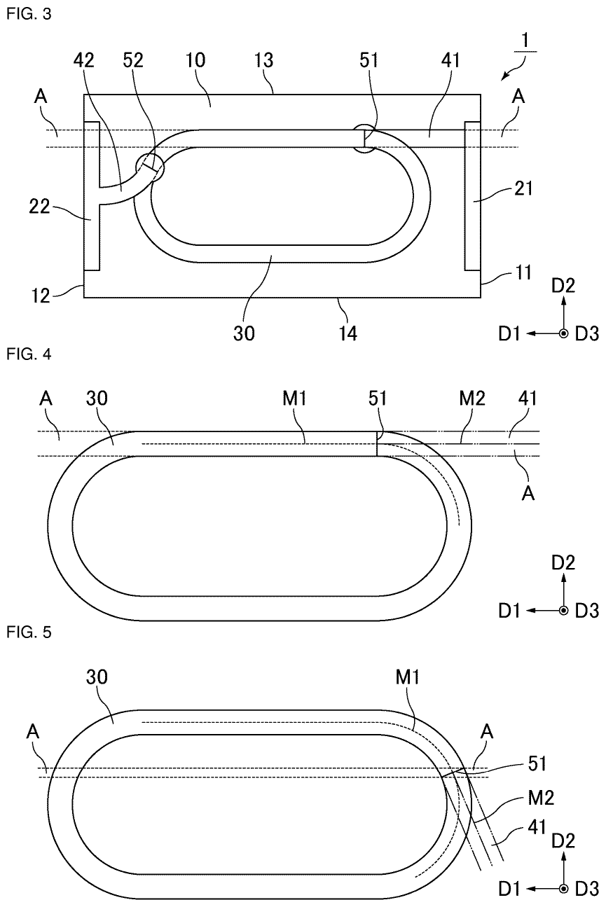

FIG. 3 illustrates the multilayer inductor 1 of FIG. 1 as viewed through in the coil-axis direction.

A first boundary 51 is the boundary between the first extended conductor 41 and the inner conductor 30. The definition of the first boundary 51 will be described later.

A second boundary 52 is the boundary between the second extended conductor 42 and the inner conductor 30. The definition of the second boundary 52 will be described later.

When the multilayer inductor 1 is viewed through in the coil-axis direction, a straight line A drawn from the first boundary 51 in the first direction D1 does not superpose the second boundary 52, which is the boundary between the second extended conductor 42 and the inner conductor 30.

When the straight line A does not need to superpose the second boundary 52, the position of the second boundary 52 between the second extended conductor 42 and the inner conductor 30 can be adjusted appropriately, which is different from the case in which the straight line A drawn from the first boundary 51 in the first direction D1 superposes the second boundary 52 between the second extended conductor 42 and the inner conductor 30. Accordingly, the length of the inner conductor 30 that serves as the coil can be adjusted. For example, this enables the second boundary 52 to be positioned so as to increase the length of the inner conductor 30 serving as the coil in order to improve the inductance of the multilayer inductor 1, as is different from the case in which the straight line A superposes the second boundary 52.

When the multilayer inductor 1 is viewed through in the coil-axis direction, the second extended conductor 42 has a curved shape that projects in a direction away from the straight line A drawn from the first boundary 51 in the first direction D1.

When the second extended conductor 42 has the curved shape that projects in a direction away from the straight line A drawn from the first boundary 51 in the first direction D1, the directional change of electric current at the second boundary 52 can be made gentle and smooth. Assume that a multilayer inductor of a comparative example (not illustrated) is configured such that the second extended conductor 42 is extended straight out from the position of the second boundary 52 in FIG. 3 in the direction parallel to the straight line A. Compared with the multilayer inductor of this example, the multilayer inductor 1 of FIG. 3 can moderate the directional change of the electric current at the second boundary 52. This can reduce the interference of the electric current at the second boundary 52, which can improve the Q-value of the multilayer inductor 1.

It is sufficient that the second extended conductor 42 have a curved portion near the second boundary 52, the curved portion having the curved shape that projects in a direction away from the straight line A drawn from the first boundary 51 in the first direction D1. In other words, it is not necessary that the entire second extended conductor 42 have the curved shape that projects in a direction away from the straight line A drawn from the first boundary 51 in the first direction D1. For example, the second extended conductor 42 may include a first curved portion that extends from the second boundary 52 and a second curved portion that extends from the first curved portion. The first curved portion may have the curved shape that projects in a direction away from the straight line A drawn from the first boundary 51 in the first direction D1, whereas the second curved portion may have a different curved shape that does not project in a direction away from the straight line A drawn from the first boundary 51 in the first direction D1. Alternatively, the second extended conductor 42 may have a curved portion that extends from the second boundary 52 and a straight portion that extends from the curved portion, and the curved portion has the curved shape that projects in a direction away from the straight line A drawn from the first boundary 51 in the first direction D1.

In the case where the first end surface 11 is not strictly parallel to the second end surface 12 and the first direction D1 is not strictly defined, the first direction D1 may be defined in the following manner. The first direction D1 may be defined as the direction of an arbitrary straight line that passes through the first end surface 11 and the second end surface 12, and when a straight line is drawn from the first boundary 51 in this direction (i.e., the first direction D1), the straight line from the first boundary 51 does not superpose the second boundary 52, and the second extended conductor 42 has the curved shape that projects in a direction away from the straight line from the first boundary 51 in this direction (i.e., the first direction D1).

When the multilayer inductor 1 is viewed through in the coil-axis direction C, the first extended conductor 41 preferably has a linear shape. The first extended conductor 41 having the linear shape can improve the Q-value of the multilayer inductor 1 compared with the case where the first extended conductor 41 has a curved shape.

In the example illustrated in FIG. 3, the first extended conductor 41 has the linear shape extending in the first direction D1. The first extended conductor 41, however, does not need to have the linear shape and does not need to extend in the first direction D1.

When the multilayer inductor 1 is viewed through in the coil-axis direction C, the first extended conductor 41 preferably has the linear shape, and the first extended conductor 41 is positioned closer to the first principal surface 15 than the second extended conductor 42 and the inner conductor 30 to the first principal surface 15. With this configuration, the multilayer inductor 1 can be designed so as to reduce the area of the extended conductor opposing the outer electrode, which can reduce the stray capacitance and thereby improve the high frequency characteristics.

FIG. 4 is a schematic view illustrating an example of the first boundary.

FIG. 4 is a view illustrating the multilayer inductor of FIG. 3 as viewed through in the coil-axis direction. FIG. 4 only illustrates the inner conductor 30 and first extended conductor 41 in order to simplify the description. Referring to FIG. 4, the following description focuses on the definition of the first boundary 51 between the first extended conductor 41 and the inner conductor 30. This description, however, also applies to the definition of the second boundary 52 between the second extended conductor 42 and the inner conductor 30.

The first boundary 51 is defined in the following manner. When the multilayer inductor is viewed through in the coil-axis direction, the center line of the first extended conductor 41 (the line indicated by M2 in FIG. 4) meets the center line of the inner conductor 30 (the line indicated by M1 in FIG. 4). The first boundary 51 is defined as a section of the first extended conductor 41 at the meeting point of both center lines, the section extending in the direction orthogonal to the center line of the first extended conductor 41.

Similarly, the second boundary 52 is defined in the following manner. When the multilayer inductor is viewed through in the coil-axis direction, the second boundary 52 is defined as a section of the second extended conductor 42 at the point at which the center line of the second extended conductor 42 meets the center line of the inner conductor 30, the section extending in the direction orthogonal to the center line of the second extended conductor 42.

The center line of the inner conductor 30 passes through the center of the width of the inner conductor 30. Similarly, the center lines of the first extended conductor 41 and the second extended conductor 42 pass through the centers of respective widths thereof.

The first boundary 51 has the same width of the first extended conductor 41. The straight line A drawn from the first boundary 51 in the first direction D1 is actually a belt-like line.

In the case where a land is present at the first boundary 51 as illustrated in FIG. 3 and the width of the first boundary 51 becomes greater than the width of first extended conductor 41, the width of the first boundary 51 may be determined as if the land were not present. In other words, the width of the first boundary 51 is assumed to be the same as the width of the first extended conductor 41 at a position where the land is not present.

FIG. 5 is a schematic view illustrating another example of the first boundary.

As illustrated in FIG. 5, the first extended conductor 41 is connected to a curved portion of the inner conductor 30. Also in this case, in which the first extended conductor 41 is connected to the curved portion of the inner conductor 30, the first boundary 51 is defined as a section of the first extended conductor 41 at the point at which the center line of the first extended conductor 41 (the line indicated by M2 in FIG. 5) meets the center line of the inner conductor 30 (the line indicated by M1 in FIG. 5), the section extending in the direction orthogonal to the center line of the first extended conductor 41.

### Second Embodiment

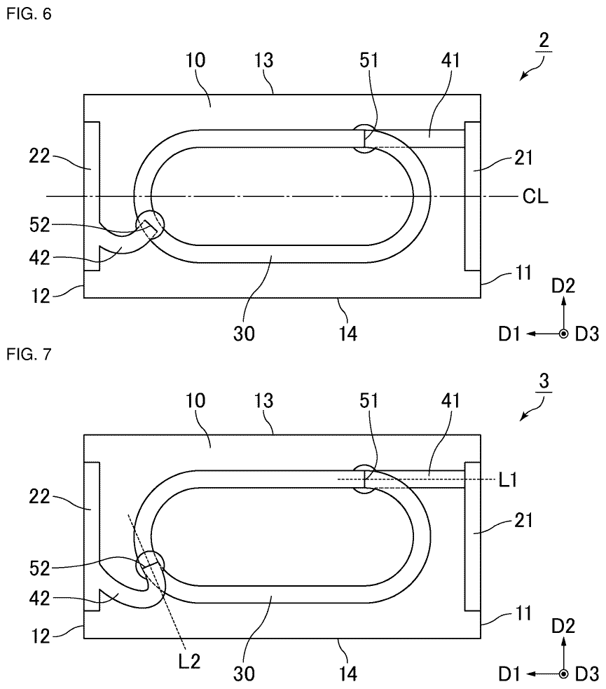

FIG. 6 is a view illustrating a multilayer inductor according to a second embodiment of the present disclosure as viewed through in the coil-axis direction.

In a multilayer inductor 2, the first side surface 13 is positioned opposite to the second side surface 14 in the second direction D2 that is orthogonal to both the first direction D1 and the coil-axis direction, as is the case for the multilayer inductor 1.

When the multilayer inductor 2 of FIG. 6 is viewed through in the coil-axis direction, the first boundary 51 is closer to the first side surface 13 than the center of the main body 10 to the first side surface 13, and the second boundary 52 is closer to the second side surface 14 than the center of the main body 10 to the second side surface 14. This structure enables the length of the inner conductor 30 serving as the coil to increase, which can improve the inductance of the multilayer inductor 2.

Assume that the center line of the main body 10 (the line indicated by CL in FIG. 6) is a straight line that is drawn so as to pass through the center of gravity of the main body 10 and extend parallel to the first direction D1 as viewed in the coil-axis direction. If the first boundary 51 is present closer to the first side surface 13 than the center line CL to the first side surface 13, it can be said that the first boundary 51 is closer to the first side surface 13 than the center of the main body 10. Similarly, if the second boundary 52 is closer to the second side surface 14 than the center line CL to the second side surface 14, it can be said that the second boundary 52 is present closer to the second side surface 14 than the center of the main body 10. Note that the center of gravity here refers to the geometric center of gravity of the main body 10 determined without taking specific gravities of the main body 10 and the inner conductor 30, etc., into account.

### Third Embodiment

FIG. 7 is a view illustrating a multilayer inductor according to a third embodiment of the present disclosure as viewed through in the coil-axis direction.

When a multilayer inductor 3 is viewed through in the coil-axis direction as illustrated in FIG. 7, the second extended conductor 42 extends in the tangential direction of a circling path of the inner conductor 30 at the second boundary 52. This can moderate the directional change of electric current, which can improve the Q-value of the multilayer inductor 3.

The first extended conductor 41 preferably extends in the tangential direction of the circling path of the inner conductor 30 at the first boundary 51. This can moderate the directional change of electric current, which can improve the Q-value of the multilayer inductor 3.

The tangent line of the circling path of the inner conductor 30 at the first boundary 51 (i.e., the line indicated by L1 in FIG. 7) refers to the tangent line of the center line of the inner conductor 30 at the first boundary 51 as viewed through in the coil-axis direction. In other words, the tangent line L1 of the circling path of the inner conductor 30 at the first boundary 51 is the straight line drawn from the first boundary 51 in the extending direction of the center line of the inner conductor 30.

Similarly, the tangent line of the circling path of the inner conductor 30 at the second boundary 52 (i.e., the line indicated by L2 in FIG. 7) refers to the tangent line of the center line of the inner conductor 30 at the second boundary 52 as viewed through in the coil-axis direction. In other words, the tangent line L2 of the circling path of the inner conductor 30 at the second boundary 52 is the straight line drawn from the second boundary 52 in the extending direction of the center line of the inner conductor 30.

The center line of the inner conductor 30 is the line passing through the center of the width of the inner conductor 30.

### Fourth Embodiment

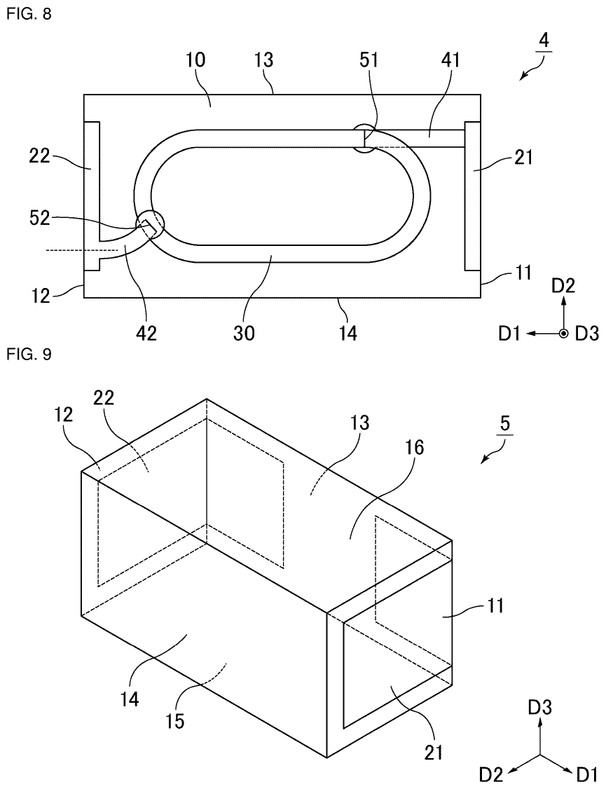

FIG. 8 is a view illustrating a multilayer inductor according to a fourth embodiment of the present disclosure as viewed through in the coil-axis direction.

When a multilayer inductor 4 is viewed through in the coil-axis direction as illustrated in FIG. 8, the second extended conductor 42 is connected to the second outer electrode 22 perpendicularly. This structure can reduce the concentration of electric current at the connection portion between the second extended conductor 42 and the second outer electrode 22, which can improve the Q-value of the multilayer inductor 4.

The second extended conductor 42 is not necessarily connected to the second outer electrode 22 perpendicularly in its strict sense as viewed through in the coil-axis direction. For example, when the second extended conductor 42 is connected to the second outer electrode 22 in a direction deviated within 5 degrees from the direction perpendicular to the second outer electrode 22, it can be said that the second extended conductor 42 is connected to the second outer electrode 22 perpendicularly.

In addition, the first extended conductor 41 is preferably connected to the first outer electrode 21 perpendicularly as viewed through in the coil-axis direction. For example, when the first extended conductor 41 is connected to the first outer electrode 21 in a direction deviated within 5 degrees from the direction perpendicular to the first outer electrode 21, it can be said that the first extended conductor 41 is connected to the first outer electrode 21 perpendicularly.

### Fifth Embodiment

FIG. 9 is a schematic perspective view illustrating an example of a multilayer inductor according to a fifth embodiment of the present disclosure.

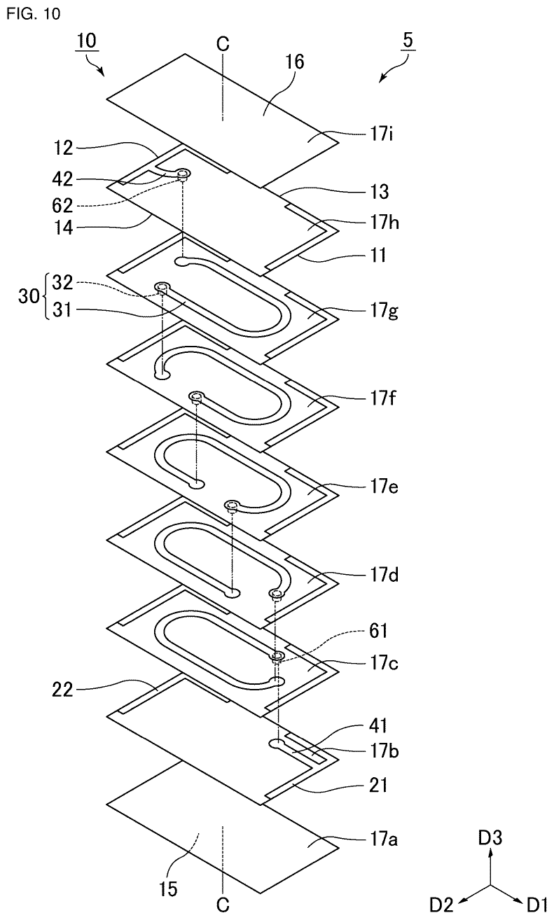

FIG. 10 is an example of an exploded perspective view illustrating the multilayer inductor of FIG. 9.

In a multilayer inductor 5 illustrated in FIGS. 9 and 10, the main body 10 includes the first side surface 13 and the second side surface 14 that are opposite to each other in the second direction D2 that is orthogonal to both the first direction D1 and the coil-axis direction C. In addition, the first outer electrode 21 is formed so as to extend on the first end surface 11 into the first side surface 13, and the second outer electrode 22 is formed so as to extend on the second end surface 12 into the first side surface 13.

The first side surface 13 of the main body 10 serves as the mounting surface of the multilayer inductor 1.

In the multilayer inductor 5 of FIG. 10, the coil-axis direction C is the direction extending parallel to the lamination direction of the main body 10. In the example illustrated in FIG. 10, the coil-axis direction C extends parallel to the third direction D3 and orthogonal to both the first direction D1 and the second direction D2.

The multilayer inductor 5 illustrated in FIG. 10 has a so-called horizontal helical structure. In other words, in the multilayer inductor 5, the coil-axis direction C is parallel to the first side surface 13, or the mounting surface, of the main body 10. The first outer electrode 21 and the second outer electrode 22 are present on the first side surface 13, which is the mounting surface of the multilayer inductor 5 that has the horizontal helical structure.

In the multilayer inductor 5, the outer electrodes formed on the first side surface 13 as well as a circuit board to be mounted on do not interfere with the magnetic flux generated by the coil, which improves the inductance and the Q-value of the multilayer inductor 5.

### Method of Manufacturing Multilayer Inductor

The multilayer inductor 1 illustrated in FIGS. 1 and 2 can be manufactured, for example, in the following process.

### Steps of Manufacturing Mother Multilayer Body

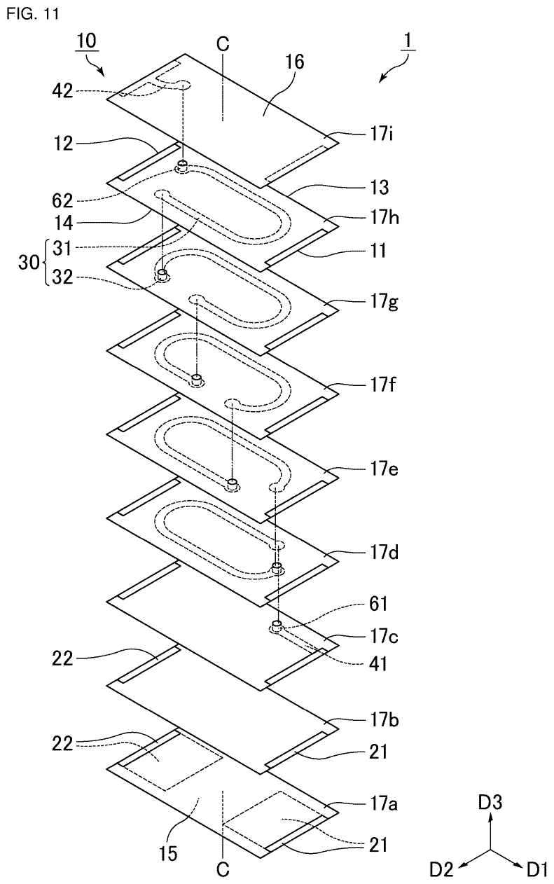

Referring to FIG. 11, the following describes example steps of forming the insulating layers, from the insulating layer 17i toward the insulating layer 17a, to manufacture a mother multilayer body.

FIG. 11 is another example of the exploded perspective view illustrating the multilayer inductor of FIG. 1.

In FIG. 2, the extended conductors and the inner conductors are each formed on the surface of the insulating layer that faces the second principal surface 16. The multilayer inductor 1 of FIG. 11 is the same in structure as the multilayer inductor 1 of FIG. 2. In FIG. 11, however, the extended conductors and the inner conductors are each formed on the surface of the insulating layer that faces the first principal surface 15. The following describes steps of manufacturing the multilayer inductor 1 illustrated in FIG. 11.

Firstly, an insulating paste containing, for example, a glass material with borosilicate glass as a main ingredient is applied repeatedly by screen printing to form an insulating paste layer. This insulating paste layer becomes the insulating layer 17i later.

Next, a photosensitive conductive paste containing, for example, a metal such as Ag as a main ingredient is applied by screen printing onto the insulating paste layer to form a photosensitive conductive paste layer thereon. The photosensitive conductive paste layer is covered with a photomask and irradiated with, for example, ultraviolet light and subsequently developed using, for example, an alkaline solution to form outer conductor layers and a second extended conductor layer on the insulating paste layer. The outer conductor layers and the second extended conductor are thus formed using photolithography. The outer conductor layers formed in this step become part of the first outer electrode 21 and part of the second outer electrode 22 later. The same also applies to outer conductor layers described in the subsequent steps. The second extended conductor layer formed in this step becomes the second extended conductor 42 later.

For example, when the outer conductor layers and the second extended conductor layer are formed, the direct imaging exposure (DI exposure) without using the photomask may be performed in place of the exposure with the photomask.

Next, a photosensitive insulating paste containing, for example, a glass material with borosilicate glass as a main ingredient is applied by screen printing onto the previously formed insulating paste layer to form a new insulating paste layer thereon. The newly formed insulating paste layer is covered with a photomask and irradiated with, for example, ultraviolet light and subsequently developed using, for example, an alkaline solution to form a via hole and cavities in the insulating paste layer. The insulating paste layer having the via hole and the cavities are thus formed using photolithography. The insulating paste layer formed in this step becomes the insulating layer 17h later. The via hole formed in this step superposes part of the previously formed second extended conductor layer. The cavities formed in this step superpose the previously formed outer conductor layers.

For example, when the insulating paste layer having the via hole and the cavities is formed, the DI exposure without using the photomask may be performed in place of the exposure with the photomask.

Next, a photosensitive conductive paste containing, for example, a metal such as Ag as a main ingredient is applied by screen printing onto the previously formed insulating paste layer and also into the via hole and the cavities, thereby forming a new photosensitive conductive paste layer. The photosensitive conductive paste layer is covered with a photomask and irradiated with, for example, ultraviolet light and subsequently developed using, for example, an alkaline solution. A connection conductor layer is thereby formed inside the via hole, and a coil conductor layer is also formed on the insulating paste layer so as to be connected to the connection conductor layer. Moreover, new outer conductor layers are thereby formed inside respective cavities so as to cover, and so as to be connected to, the previously formed outer conductor layers. The coil conductor layer, the connection conductor layer, and the outer conductor layers are thus formed using photolithography. The coil conductor layer formed in this step becomes the coil conductors 31 later. The connection conductor layer formed in this step becomes the second via conductor 62 later.

For example, when the coil conductor layer, the connection conductor layer, and the outer conductor layers are formed, the DI exposure without using the photomask may be performed in place of the exposure with the photomask.

The above steps are repeated to form a predetermined multilayer structure consisting of insulating paste layers, coil conductor layers, connection conductor layers, and outer conductor layers. The insulating paste layers formed here later become the insulating layer 17g, the insulating layer 17f, the insulating layer 17e, and the insulating layer 17d. The coil conductor layers formed here becomes the coil conductors 31 later. The connection conductor layers formed here becomes the connection conductors 32 later.

Next, a photosensitive insulating paste containing, for example, a glass material with borosilicate glass as a main ingredient is applied by screen printing onto the previously formed insulating paste layer to form a new insulating paste layer thereon. The newly formed insulating paste layer is covered with a photomask and irradiated with, for example, ultraviolet light and subsequently developed using, for example, an alkaline solution to form a via hole and cavities in the insulating paste layer. The insulating paste layer having the via hole and the cavities are thus formed using photolithography. This insulating paste layer formed in this step becomes the insulating layer 17c later. The via hole formed in this step superposes part of the previously formed coil conductor layer. The cavities formed in this step superpose the previously formed outer conductor layers.

For example, when the insulating paste layer having the via hole and the cavities is formed, the DI exposure without using the photomask may be performed in place of the exposure with the photomask.

Next, a photosensitive conductive paste containing, for example, a metal such as Ag as a main ingredient is applied by screen printing onto the previously formed insulating paste layer and also into the via hole and the cavities, thereby forming a new photosensitive conductive paste layer. The photosensitive conductive paste layer is covered with a photomask and irradiated with, for example, ultraviolet light and subsequently developed using, for example, an alkaline solution. A connection conductor layer is thereby formed inside the via hole, and a first extended conductor layer is also formed on the insulating paste layer so as to be connected to the connection conductor layer. Moreover, new outer conductor layers are thereby formed inside respective cavities so as to cover, and so as to be connected to, the previously formed outer conductor layers. The connection conductor layer, the outer conductor layers, and the first extended conductor are thus formed using photolithography. The connection conductor layer formed in this step becomes the first via conductor 61 later. The first extended conductor layer formed in this step becomes the first extended conductor 41 later.

For example, when the connection conductor layer, the outer conductor layers, and the first extended conductor layer are formed, the DI exposure without using the photomask may be performed in place of the exposure with the photomask.

Next, a photosensitive insulating paste containing, for example, a glass material with borosilicate glass as a main ingredient is applied by screen printing onto the previously formed insulating paste layer to form a new insulating paste layer thereon. The newly formed insulating paste layer is covered with a photomask and irradiated with, for example, ultraviolet light and subsequently developed using, for example, an alkaline solution to form cavities in the insulating paste layer. The insulating paste layer having the cavities are thus formed using photolithography. This insulating paste layer formed in this step becomes the insulating layer 17b later. The cavities formed in this step superpose the previously formed outer conductor layers.

For example, when the insulating paste layer having the cavities is formed, the DI exposure without using the photomask may be performed in place of the exposure with the photomask.

Next, a photosensitive conductive paste containing, for example, a metal such as Ag as a main ingredient is applied by screen printing to form a new photosensitive conductive paste layer inside the cavities. The photosensitive conductive paste layer is covered with a photomask and irradiated with, for example, ultraviolet light and subsequently developed using, for example, an alkaline solution. New outer conductor layers are thereby formed inside respective cavities so as to cover, and so as to be connected to, the previously formed outer conductor layers. The outer conductor layers are thus formed using photolithography.

For example, when the outer conductor layers are formed, the DI exposure without using the photomask may be performed in place of the exposure with the photomask.

Next, the photosensitive insulating paste is applied by screen printing onto the previously formed insulating paste layer to form a new insulating paste layer thereon. The newly formed insulating paste layer is covered with a photomask and irradiated with, for example, ultraviolet light and subsequently developed using, for example, an alkaline solution to form cavities in the insulating paste layer. The insulating paste layer having the cavities are thus formed using photolithography. This insulating paste layer formed in this step becomes the insulating layer 17a later. The cavities formed in this step superpose the previously formed outer conductor layers. Subsequently, cavities for forming outer conductors, which are part of the first outer electrode 21 and part of the second outer electrode 22 to be exposed on the first principal surface 15 of the main body 10, are formed at a surface that later becomes the first principal surface 15 of the main body 10.

For example, when the insulating paste layer having the cavities is formed, the DI exposure without using the photomask may be performed in place of the exposure with the photomask.

Next, a photosensitive conductive paste containing, for example, a metal such as Ag as a main ingredient is applied by screen printing into the cavities to form a new photosensitive conductive paste layer. The photosensitive conductive paste layer is covered with a photomask and irradiated with, for example, ultraviolet light and subsequently developed using, for example, an alkaline solution. New outer conductor layers are thereby formed inside respective cavities so as to cover, and so as to be connected to, the previously formed outer conductor layers. Outer conductor layers are formed at a surface that later becomes the first principal surface 15 of the main body 10. These outer conductor layers later become part of the first outer electrode 21 and part of the second outer electrode 22 to be exposed on the first principal surface 15 of the main body 10. The outer conductor layers formed in this step may be formed so as to be flush with the first principal surface 15 of the main body 10 or may be formed so as to rise from the first principal surface 15. The outer conductor layers are thus formed using photolithography.

For example, when the outer conductor layers are formed, the DI exposure without using the photomask may be performed in place of the exposure with the photomask.

Note that the resolution limit in development is 3 μm or less using the above photosensitive insulating paste with ultraviolet light irradiation at a source wavelength of 365/405 nm.

The mother multilayer body is thus manufactured.

The method of patterning conductor traces of the coil conductor layer, the connection conductor layer, the outer conductor layers, the first extended conductor layer, and the second extended conductor layer are not limited to the photolithography. For example, the conductive paste may be applied using a screen-printing plate having openings that correspond to the conductor traces. Alternatively, a conductive film may be first formed using sputtering, vapor deposition, or pressure bonding of a foil, and the conductive film is subsequently etched to form the conductor traces. Alternatively, the semi-additive process may be used to form a negative pattern of the conductor traces for subsequent plating, and unwanted portions of the plated film may be etched away to leave the conductor traces.

When forming the coil conductor layer, the connection conductor layer, the outer conductor layers, the first extended conductor layer, and the second extended conductor layer, the conductor traces can be built up in a multilayered manner to increase the aspect ratio of conductor trace, thereby reducing the resistive loss of high-frequency current. The method of building up the conductor traces in the multilayered manner is not limited to the above, in other words, repeating the step using the photolithography. The conductor traces may be built up repeatedly using the semi-additive process. Alternatively, the conductor traces may be formed first using the semi-additive process, and subsequently new conductor traces may be formed over the previously formed conductor traces using plating and etching, and vice versa. Alternatively, the conductor traces formed using the semi-additive process may be built up by further plating.

The conductive material of the conductor traces of the coil conductor layer, the connection conductor layer, the outer conductor layers, the first extended conductor layer, and the second extended conductor layer is not limited to the above-described photosensitive conductive paste containing a metal such as Ag as a main ingredient. The conductive material may be a material containing a metal such as Ag, Au, or Cu to form these conductor layers using sputtering, vapor deposition, pressure bonding of a foil, plating, or the like.

The method of forming the insulating paste layer is not limited to the above-described photolithography but may be pressure bonding of an insulating sheet or spin-coating or spray-coating of an insulating material.

The method of forming the insulating paste layer having the via hole and the cavities is not limited to the above-described photolithography. For example, an insulating film may be formed first using pressure bonding of an insulating sheet, spin-coating or spray-coating of an insulating material, or the like, and subsequently the via hole and the cavities may be formed in the insulating film using laser, drilling, or the like.

The insulating material of the insulating paste layer is not limited to the above-described glass material containing borosilicate glass as a main ingredient. For example, the insulating material may be a ceramic material; an organic material, such as epoxy resin, fluororesin, or a polymer resin; or a composite material such as glass-epoxy resin. The insulating material is preferably a material of which the dielectric constant and the dielectric loss are small.

### Steps of Forming Main Body, Coil, and Outer Electrodes

The mother multilayer body is cut into multiple unsintered multilayer bodies using, for example, a dicing machine.

An unsintered multilayer body includes a laminated insulating-paste portion formed by laminating the insulating paste layers, a laminated coil conductor portion formed by laminating the coil conductor layers in such a manner that adjacent coil conductor layers are electrically connected by an connection conductor layer, laminated outer conductor portions formed by laminating the outer conductor layers, a first extended conductor portion formed of the first extended conductor layer, and a second extended conductor portion formed of the second extended conductor layer.

When the mother multilayer body is cut into unsintered multilayer bodies, the mother multilayer body is cut at respective laminated outer conductor portions in such a manner that the laminated outer conductor portions of each multilayer body are exposed at two positions at least at the bottom surface of the laminated insulating-paste portion.

Next, each unsintered multilayer body is sintered to produce a multilayer body.

By sintering the unsintered multilayer body, the insulating paste layer becomes the insulating layer, and accordingly the laminated insulating-paste portion becomes the main body 10. By sintering the unsintered multilayer body, the coil conductor layer becomes the coil conductor, and accordingly the laminated coil conductor portion becomes the inner conductor 30. By sintering the unsintered multilayer body, one of the two laminated outer conductor portions becomes part of the first outer electrode 21 and the other becomes part of the second outer electrode 22. By sintering the unsintered multilayer body, the first extended conductor portion becomes the first extended conductor 41 and the second extended conductor portion becomes the second extended conductor 42.

Next, the multilayer body obtained may be subjected to barrel polishing to round edges and vertices of the main body 10.

Finally, the two laminated outer conductor portions of the sintered multilayer body are plated to form outer electrodes. The laminated outer conductor portions may serve as base layers, and Ni-plating layers may be formed on respective base layers, and subsequently Sn-plating layers may be formed on respective Ni-plating layers. For example, the thickness of the Ni-plating layer and the Sn-plating layer is each 2 μm or more and 10 μm or less (i.e., from 2 μm to 10 μm).

Thus, each of the first outer electrode 21 and the second outer electrode 22 is formed so as to have the base layer, the Ni-plating layer, and the Sn-plating layer laminated in this order from the surface of the main body 10. In the first outer electrode 21, the base layer may be formed so as to be flush with the surface of the main body 10 (more specifically, the first end surface 11 and the first principal surface 15 of the main body 10 in FIG. 1), and the Ni-plating layer and the Sn-plating layer may rise from the surface of the main body 10 (more specifically, the first end surface 11 and the first principal surface 15 of the main body 10 in FIG. 1) so as to cover the base layer. In the second outer electrode 22, the base layer may be formed so as to be flush with the surface of the main body 10 (more specifically, the second end surface 12 and the first principal surface 15 of the main body 10 in FIG. 1), and the Ni-plating layer and the Sn-plating layer may rise from the surface of the main body 10 (more specifically, the second end surface 12 and the first principal surface 15 of the main body 10 in FIG. 1) so as to cover the base layer.

The first outer electrode 21 and the second outer electrode 22 may include the base layer only and do not need to include the Ni-plating layer and the Sn-plating layer. The first outer electrode 21 and the second outer electrode 22 may include a different plating layer, such as an Au layer, in place of the Ni-plating layer and the Sn-plating layer.

The method of forming the outer electrodes is not limited to the above, in other words, plating the laminated outer conductor portions exposed on the cut surfaces (at least at the bottom surface of the laminated insulating-paste portion) of the unsintered multilayer body. For example, the laminated outer conductor portions may be exposed first at respective cut surfaces (at least at the bottom surface of the laminated insulating-paste portion) of the unsintered multilayer body, and the exposed portions may be dipped in the conductive paste or may be covered with the conductive paste by sputtering, and subsequently the exposed portions may be subjected to plating.

The multilayer inductor 1 is thus produced.

The multilayer inductor 1 is produced as a so-called “0402 size” product (having the dimensions of 0.4 mm by 0.2 mm by 0.2 mm). The size of the multilayer inductor 1 is not limited to the “0402 size”.

The following summarizes the points disclosed in the present specification.

[1] A multilayer inductor includes: a main body having a first end surface and a second end surface that are opposite to each other in a first direction; a first outer electrode formed on the first end surface; a second outer electrode formed on the second end surface; an inner conductor formed inside the main body and wound around a coil axis extending in a coil-axis direction that is orthogonal to the first direction; a first extended conductor formed inside the main body so as to connect the inner conductor to the first outer electrode; and a second extended conductor formed inside the main body so as to connect the inner conductor to the second outer electrode. As viewed through in the coil-axis direction, when a straight line is drawn in the first direction from a first boundary between the first extended conductor and the inner conductor, the straight line does not superpose a second boundary between the second extended conductor and the inner conductor. In addition, as viewed through in the coil-axis direction, the second extended conductor is curved such that the curved portion projects in a direction extending away from the straight line.

[2] In the multilayer inductor according to [1] above, the main body has a first side surface and a second side surface that are opposite to each other in a second direction that is orthogonal to both the first direction and the coil-axis direction, and as viewed through in the coil-axis direction, the first boundary is closer to the first side surface than a center of the main body to the first side surface, and the second boundary is closer to the second side surface than the center of the main body to the second side surface.

[3] In the multilayer inductor according to [1] or [2] above, as viewed through in the coil-axis direction, the first extended conductor extends straight.

[4] In the multilayer inductor according to any one of [1] to [3] above, as viewed through in the coil-axis direction, the second extended conductor branches off from the inner conductor at the second boundary in a tangential direction.

[5] In the multilayer inductor according to any one of [1] to [4] above, as viewed through in the coil-axis direction, the second extended conductor is connected perpendicularly to the second outer electrode.

[6] In the multilayer inductor according to any one of [1] to [5] above, the first extended conductor, the inner conductor, and the second extended conductor are layered in this order from one side to another in the coil-axis direction. In addition, the inner conductor is connected to the first extended conductor using a first via conductor, and the inner conductor is connected to the second extended conductor using a second via conductor.

[7] In the multilayer inductor according to any one of [1] to [6] above, the main body has a first principal surface and a second principal surface that are opposite to each other in the coil-axis direction. In addition, the first outer electrode extends on the first end surface into the first principal surface, and the second outer electrode extends on the second end surface into the first principal surface.

[8] In the multilayer inductor according to [7] above, as viewed through in the coil-axis direction, the first extended conductor extends straight, and the first extended conductor is closer to the first principal surface than the second extended conductor and the inner conductor to the first principal surface.

[9] In the multilayer inductor according to any one of [1] to [6] above, the main body has the first side surface and the second side surface that are opposite to each other in the second direction that orthogonally intersects both the first direction and the coil-axis direction. In addition, the first outer electrode extends on the first end surface into the first side surface, and the second outer electrode extends on the second end surface into the first side surface.

What is claimed is:

1. A multilayer inductor comprising:
a main body having a first end surface and a second end surface that are opposite to each other in a first direction;
a first outer electrode on the first end surface;
a second outer electrode on the second end surface;
an inner conductor inside the main body and wound around a coil axis extending in a coil-axis direction that is orthogonal to the first direction;
a first extended conductor inside the main body to connect the inner conductor to the first outer electrode; and
a second extended conductor inside the main body to connect the inner conductor to the second outer electrode, wherein
as viewed through in the coil-axis direction, when a straight line is drawn in the first direction from a first boundary between the first extended conductor and the inner conductor, the straight line does not overlap a second boundary between the second extended conductor and the inner conductor, and
as viewed through in the coil-axis direction, the second extended conductor is curved such that a curved portion projects in a direction away from the straight line drawn in the first direction from the first boundary.

2. The multilayer inductor according to claim 1, wherein
the main body has a first side surface and a second side surface that are opposite to each other in a second direction that is orthogonal to both the first direction and the coil-axis direction, and
as viewed through in the coil-axis direction, the first boundary is closer to the first side surface with respect to a center of the main body, and the second boundary is closer to the second side surface with respect to the center of the main body.

3. The multilayer inductor according to claim 1, wherein
as viewed through in the coil-axis direction, the first extended conductor extends straight.

4. The multilayer inductor according to claim 1, wherein
as viewed through in the coil-axis direction, the second extended conductor extends in a tangential direction of a circling path of the inner conductor at the second boundary.

5. The multilayer inductor according to claim 1, wherein
as viewed through in the coil-axis direction, the second extended conductor is connected perpendicularly to the second outer electrode.

6. The multilayer inductor according to claim 1, wherein
the first extended conductor, the inner conductor, and the second extended conductor are stacked in this order from one side to another in the coil-axis direction,
the inner conductor is connected to the first extended conductor through a first via conductor, and
the inner conductor is connected to the second extended conductor through a second via conductor.

7. The multilayer inductor according to claim 1, wherein
the main body has a first principal surface and a second principal surface that are opposite to each other in the coil-axis direction,
the first outer electrode extends from the first end surface to the first principal surface, and
the second outer electrode extends from the second end surface to the first principal surface.

8. The multilayer inductor according to claim 7, wherein
as viewed through in the coil-axis direction, the first extended conductor extends straight, and
the first extended conductor is closer to the first principal surface than the second extended conductor and the inner conductor.

9. The multilayer inductor according to claim 1, wherein
the main body has a first side surface and a second side surface that are opposite to each other in a second direction that is orthogonal to both the first direction and the coil-axis direction,
the first outer electrode extends from the first end surface to the first side surface, and
the second outer electrode extends from the second end surface to the first side surface.

10. The multilayer inductor according to claim 2, wherein
as viewed through in the coil-axis direction, the first extended conductor extends straight.

11. The multilayer inductor according to claim 2, wherein
as viewed through in the coil-axis direction, the second extended conductor extends in a tangential direction of a circling path of the inner conductor at the second boundary.

12. The multilayer inductor according to claim 2, wherein
as viewed through in the coil-axis direction, the second extended conductor is connected perpendicularly to the second outer electrode.

13. The multilayer inductor according to claim 2, wherein
the first extended conductor, the inner conductor, and the second extended conductor are stacked in this order from one side to another in the coil-axis direction,
the inner conductor is connected to the first extended conductor through a first via conductor, and
the inner conductor is connected to the second extended conductor through a second via conductor.

14. The multilayer inductor according to claim 2, wherein
the main body has a first principal surface and a second principal surface that are opposite to each other in the coil-axis direction,
the first outer electrode extends from the first end surface to the first principal surface, and
the second outer electrode extends from the second end surface to the first principal surface.

15. The multilayer inductor according to claim 14, wherein
as viewed through in the coil-axis direction, the first extended conductor extends straight, and
the first extended conductor is closer to the first principal surface than the second extended conductor and the inner conductor.

16. The multilayer inductor according to claim 2, wherein
the first outer electrode extends from the first end surface to the first side surface, and
the second outer electrode extends from the second end surface to the first side surface.
